(19) United States
(12) Patent Application Publication
(10) Pub. No.: US 2022/0270576 A1
(43) Pub. Date: Aug. 25, 2022

(54) EMULATING A VIRTUAL INSTRUMENT FROM A CONTINUOUS MOVEMENT VIA A MIDI PROTOCOL

(71) Applicant: MICTIC AG, CH-8004 ZÜRICH (CH)

(72) Inventors: Rolf HELLAT, Zürich (CH); Martin STÄHELI, Winterthur (CH); Adrian MEIER, Rüti (CH)

(73) Assignee: MICTIC AG, CH-8004 ZÜRICH (CH)

(21) Appl. No.: 17/628,392

(22) PCT Filed: Jul. 19, 2019
(86) PCT No.: PCT/EP2019/069584

§ 371 Date: Jan. 19, 2022

(51) Int. Cl. G10H 1/00

(52) U.S. Cl. CPC G10H 1/0066; G10H 1/0025; G10H 2220/201; G10H 2220/401; G10H 2240/211

(57) ABSTRACT

The present invention relates to methods and systems for creating a sound effect out of a continuous movement, in particular by means of detecting a continuous movement through a force sensor in a device. A method is shown for creating a sound effect out of a continuous movement. The method comprises a step of providing a first device, where-by the device is adapted at detecting continuous movement and a no-movement state. The method further comprises the step of defining at least one first parameter of movement, in particular a first axis of movement of said continuous movement. A further step comprises the assigning at least one first midi-channel to the first axis of movement. A base-line value is defined for the no-movement state, and along that first axis of movement a range of values is relative to said base-line value is defined. This range of values is relative to said base-line value is reflective of a continuous movement along that first axis of movement. A sound effect is then output relative to the detected continuous movement. One aspect or additional embodiment of the present invention comprises the step of defining at least one first parameter of movement, whereby said first parameter of movement is an angular range in one axis X, Y, Z of an orientation in space of the first device (99.1) adapted at detecting continuous movement (A.1) and a no-movement state.

### BACKGROUND OF THE INVENTION

### Field of the Invention

The present invention relates to methods and systems for creating a sound effect out of a continuous movement, in particular by means of detecting a continuous movement through a force sensor in a device.

The invention further relates to an implementation of the method for creating a sound effect out of a continuous movement in the form of a number of synchronized devices and a computer program product adapted at executing the said method, whereby the executing can be performed on a computer capable at performing the said method. The method of the present invention is further outlined in the preambles of the independent claims.

### Discussion of Related Art

Devices able to convert a detected force resulting from the movement of a person into a digital signal are known in the entertainment industry. Such devices are used, for instance, with gaming consoles, where controllers are equipped with motion sensors that transform a detected movement into any sort of output, such as visual or auditive signals, for example. Most of these devices work with a wireless connection and an associated base station, which comprises a processor that receives the wirelessly transmitted signals and is in a working connection with an output unit, such as a display or loud-speaker, for outputting the signal. For ensuring an immersive experience, the latency between the detection of the signal and the output of the respective sound effect should not exceed a certain threshold.

WO 2018/115488 A1 describes an arrangement and method for the conversion of one detected force from the movement of a sensing unit into an auditory signal. The content of this publication is included herein by reference. This document teaches an arrangement that comprises at least one sensor for generating a force signal from at least one detected force, whereby the arrangement comprises a sensing unit for that purpose.

The arrangement further comprises a processing unit which is configured for converting the force signal into a digital auditory signal. As digital auditory signal a midi-signal is proposed.

The document further describes an application of its disclosure for “sound painting”, an activity where one or more of these sensing units are used to detect a position relative to a starting position, a speed of a movement and a turning of the sensing unit as well as a beating of the sensing unit to create a live sound corresponding to the movement pattern. This “sound painting” can be supported by means of machine learning for matching the force signal to a pre-learned movement sequence.

Further along the line of this document teaching the use of devices able to convert a detected force resulting from the movement of a person into a digital signal for artistic and dance performance purposes it is desirable to completely simulate an instrument by means of devices capable of transforming a movement pattern into a specific sound effect. For this purpose, a particular challenge lies in how the method handles continuous movements, i.e., movements that after an initial acceleration maintain a certain course or describe a movement pattern with varying acceleration states, such as curves or faster and slower paces within the movement.

There is therefore a need in the art to provide a method and a system capable of creating a sound effect out of a continuous movement, whereby the sound effect provides an entertainment experience that is as immersive as possible and overcomes at least one of the disadvantages of the prior art.

### SUMMARY OF THE INVENTION

It is therefore an object of the present invention to provide such a method and system as described above, that overcomes at least one of the disadvantages of the prior art. It is a further object of the present invention to provide a system with at least one device, that is capable to convert a continuous movement of the at least one device into sound effects.

One particular object of the present invention is the providing a simulation of a musical instrument by means of devices adapted at sensing movement and methods for converting movement into sound effect.

At least one of the objects of the present invention has been solved with a method and system according to the characterizing portions of the independent claims.

One aspect of the present invention is a method for creating a sound effect out of a continuous movement. The method comprises a step of providing a first device, whereby the device is adapted at detecting continuous movement and a no-movement state.

The method further comprises the step of defining at least one first parameter of movement, in particular a first axis of movement of said continuous movement.

A further step comprises the assigning at least one first midi-channel to the first axis of movement. A baseline value is defined for the no-movement state, and along that first axis of movement a range of values is relative to said baseline value is defined. This range of values is relative to said baseline value is reflective of a continuous movement along that first axis of movement. A sound effect is then output relative to the detected continuous movement.

With the method of the present invention it is possible to generate sound effects based on the movement of the first device and provide all these sound effects to an output device in a manner that enables an immersive experience.

One aspect or additional embodiment of the present invention comprises the step of defining at least one first parameter of movement, whereby said first parameter of movement is an angular range in one axis X, Y, Z of an orientation in space of the first device (99.1) adapted at detecting continuous movement (A.1) and a no-movement state.

In a particular embodiment the angular range is defined in a plurality of axes X, Y, Z, such that a three-dimensional object is defined by the axes, in particular a conical shape departing from a point on the first device.

In the context of the present invention a continuous movement can be understood as a movement that is not interrupted by stops. The movement has a certain start point from which a first initial acceleration shifts from a movement state to a movement state. The continuous movement can comprise a series of gestures, for instance such as performing a circular movement, or a zig-zag movement, a rotation along an axis et cetera. A characteristic of the continuous movement can be that it is not stopped. As soon as a movement stops, a non-movement state can be recorded, and a renewed movement be considered a different continuous movement from the previous one. For the sake of the present invention the continuous movement and non-movement state can be regarded as continuous movement or non-movement state of the device in question, i.e., first device and/or second device and/or third device etc.

In the context of the present invention a non-movement state is a static state, where no relative acceleration of the device registering the movement respective to the user is detected.

For the context of the present invention, midi is a standardized specification for electronic musical instruments.

In a particular embodiment of the present invention, the device(s) is or/are further adapted at detecting an end and/or a start of the non-movement state. This can be achieved, for instance by providing the device with a force sensing element and/or a sensor for detecting an absolute or relative motion, such as, for instance, an accelerometer for measuring and detecting linear acceleration, a gyroscope, a magnetometer, GPS etc. Sample continuous movements detected by such a device with one or more respective force sensing elements can be flicks of the wrist, sweep of the arm, drumming, tapping, punching, shaking etc.

In a further particular embodiment, this detection of an end and/or a start of the non-movement state is used to generate a midi-on and/or a midi-off signal, respectively. In an even further particular embodiment detection of an end and/or a start of the non-movement state is used to generate a midi-on and/or a midi-off signal and the signal is made to comprise further information such as a velocity of the movement associated with the start of the non-movement state. This further information can be used to define volume of timbre of the resulting sound effect.

In a further embodiment of the present invention, the at least one device is provided that is adapted at detecting a second continuous movement and a second no-movement state. This can be archived by providing a second device.

In a particular example, two devices can be used to generate two sets of sound effects either simultaneously, or by means of the two devices being adapted at operating together to generate a particular sound effect, for instance by having the first device continuous movement information used to determine a tonal-sound and the second device continuous movement information used to determine a tone pitch.

In a further particular example, the first device can be used to generate sound effects that in respect to tonal sound. Whereas the second device can be used to generate sound effects reflective of the timber. There are virtually no limits in how many devices can be connected and on what each device is defined to produce in either simultaneous sound effect generation or in cooperative sound effects. For instance, it is conceivable to generate and simulate the use of a bimanually operated instrument by using two devices. In a further particular example, it is conceivable to adapt one device at producing sound effects reflective of guitar strings being strummed and a second device at simulating the fretting with the left hand.

In a particular embodiment, a sound volume is attributed to a speed of a continuous movement.

In a further particular embodiment of the present invention, a midi note-on is generated upon detection of an end of the non-movement state.

In a particular embodiment, the outputting is performed by an outputting device.

In a further particular embodiment, the outputting device is equipped with at least one loudspeaker or capable of establishing a communication with at least one loudspeaker. For instance, a processor can be used to generate out of the midi-channel and/or midi-on/midi-off signals received by the outputting device a sound effect. The outputting device can be equipped with a plurality of loudspeakers for generating various sound effects. For instance, the outputting device can be equipped with a bass speaker. The outputting device can also be equipped with a display for generating a visual representation of the sound effect. This visual representation can be used, for instance, for teaching purposes and for refinement of particular movements associated with the generation of a sound effect with a musical instrument.

In a particular embodiment, the method of the present invention further comprises the step of accessing a number of predetermined and stored sound effects. The accessing can be performed, for instance, by means of selecting a type of musical instrument to be simulated with the method of the present invention, and/or by means of selecting a particular type of sound effect for a particular genus of continuous movements. It is also possible to attribute a particular set of sound effects to one particular device used in a method according to the present invention. It is further possible, for instance, to select from a series of sound effects simulating nature sounds and attribute them to a particular device. A further example can comprise attributing to a first or second device sound effects reflective to the usage of a particular instrument and/or vocal sounds. Combining the movement of two devices can then result in a two-voice reproduction reflective of the underlying movement.

In a particular embodiment, a cluster analysis is applied before accessing a number of predetermined and stored continuous movement patterns and/or accessing a number of predetermined and stored sound effects for pre-evaluating a detected continuous movement and determining a genus of a continuous movement and selecting a particular type of sound effect for the particular genus of the continuous movements from the number of predetermined and stored continuous movement patterns and/or the number of predetermined and stored sound effects.

In a particular embodiment, the outputting device is a smartphone.

In a further particular embodiment, the output device further comprises at least on wireless communication unit.

In a particular embodiment of the present invention, the method further comprises receiving at least one first midi-channel with an outputting device.

In a further particular embodiment, the method of the present invention comprises receiving a plurality of midi-channels from a plurality of devices adapted at detecting continuous movement and a no-movement state, such that a plurality of midi-channels is generated from the plurality of continuous movements detected.

In a particular embodiment of the present invention, a priority is attributed to a midi-continuous-controller-message received by the outputting device. Even more particularly, a priority is attributed to the midi-continuous-controller-message with the greatest change in continuous movement.

In the context of the present invention, the change in in continuous movement can be understood as change between a first measured value reflective of the movement and a second measured value reflective of the movement. The greater the difference between the first and second measured values, the higher the priority attributed to the midi-continuous-controller-message.

In a particular embodiment of the present invention, the receiving is a wireless receiving. Even more particularly, the wireless receiving is performed by means of short-wavelength radio wave, preferably by means of a Bluetooth protocol.

In a particular embodiment of the present invention, at least one second axis and/or at least one third axis is/are defined for that continuous movement. Particularly preferred, as many axes are defined as required to completely reflect the continuous movement in three-dimensional space.

In a particular embodiment of the present invention, the first device is adapted at detecting a continuous movement and a non-movement state and is assigned to an anatomical plane of the user. The sound effect is reflective of the detected continuous movement in that anatomical plane and is predetermined based on that plane. For instance, as a means of defining various planes, a horizontal plane can be defined where everything above the waist in a first quadrant, right of the median plane and above of the horizontal plane is associated with a particular set of sound effects, whereas all movement on the left of the median plane and above the horizontal plane can be associated with another set of sound effects.

It is a particular embodiment of the present invention, that this attribution can be performed individually for each device used in the method. With other words, the sound effect generated is different depending on whether the continuous movement is detected in a first quadrant or in a second quadrant, whereby the first quadrant is to the right of the median plane and above the horizontal plane relative to the user and the second plane is to the left of the median plane and above the horizontal plane of the user. At the same time, a second device can be defined with a first quadrant in the left of the median plane of the user and above the horizontal plane of the user and a second quadrant to the right of the median plane of the user and above the horizontal plane of the user.

In a further particular embodiment, a series of subplanes can be defined for further refining a set of sound effects.

In a particular example, where four devices are used, each one attached to an extremity each of the devices is defined to generate a set of sound effects dependent on a first quadrant, where the devices are usually located when the person is standing upright and not moving. A first quadrant for the first device can be above the horizontal plane and to the right of the median plane (for right-handed users) a first quadrant for a second device can be to the left of the median plane and above the horizontal plane for a left-handed user. A first quadrant for a third device can be below the horizontal plane and to the right of the median plane for a device attached to the right leg and a fourth quadrant can be to the left of the median and below the horizontal plane for a fourth device attached to the left leg of a user.

In a particular embodiment of the present invention, a plurality of devices is provided and to each device an anatomical plane of the user is assigned, and the sound effect is relative to the detected continuous movement in that anatomical plane and is predetermined based on that anatomical plane.

In a particular embodiment of the present invention, the midi-channel is a midi-CC-channel and the values all values are ranging from 0 to 127.

In a particular embodiment of the present invention, the bane baseline value is set at 64 and for a movement in a first direction along that first axis of moment the range of values relative to that baseline ranges from 0 to 63 and for a movement in a second direction along that first axis of movement the range of values relative to that baseline value ranges from 65 to 127.

In a further embodiment of the present invention, the providing a first device adapted at a detecting continuous movement and a no-movement state comprises providing a device with a processing unit adapted at a recognizing a pre-learned movement sequence out of force signal(s) detected by at least one sensor for generating a force signal from the at least one detected force. Particularly preferred, this is performed by applying a machine learning algorithm and converting that movement sequence into a digital auditory signal in particular a midi-signal, further in particular a midi-CC and/or midi-on and/or midi-off.

In a particular embodiment of the present invention, the device is adapted to be affixed to an extremity of a user.

In one further particular embodiment, this can be done by having a latch of the device, that can be used to affix the device to an extremity of a user. Further means for affixing the device to an extremity of a user are, of course, conceivable, such as adhesive surfaces, Velcro, et cetera.

With the method of the present invention, a method is provided with which a large number of musical instruments can be simulated by transforming movement, in particular continuous movement into sound effects.

One further aspect of the present invention relates to a system for managing transmissions of a plurality of devices adapted at detecting a movement and generating a movement specific midi-signal. Particularly preferred, the movement specific midi-signal is a midi-on note and/or a midi-off note and/or a midi-CC-channel with values ranging from 0 to 127.

The transmissions are wirelessly transmitted from the plurality of devices to an output unit. Each signal comprises information convertible to a sound effect by the output unit. In this aspect of the present invention, each signal is output with a latency between a force sensing and output by the output unit of maximally 30 milliseconds. Particularly preferred the latency between a force sensing and output by the output unit is between 10 and 20 milliseconds, even more preferably is around 15 milliseconds.

For the system of the present invention, each signal is packed in a transmission package consisting of four information blocks selected from the group consisting of midi-on note and/or midi-off note and/or midi-CC-channel. The transmission packs are prioritized in where the transmissions with signals containing the highest variation are preferred. In other words, the system is adapted to prioritize transmissions for signals containing the highest number of variations.

In an additional or alternative embodiment, the transmission packs with midi-on information blocks are prioritized. In other word, the system is adapted to prioritize transmission packs with midi-on information blocks.

In a particular embodiment, the system is adapted to transmit the transmissions by means of a communication protocol. More preferably the communication protocol is a short-wavelength radio-wave based communication protocol, such as, for instance, a Bluetooth protocol as defined in the relevant Bluetooth standard.

In a particular embodiment of the present invention, the system is adapted for transmitting transmission packs in the size of between 1 and 30 milliseconds, preferably of between 10 and 20 milliseconds, even more preferably of 15 milliseconds or of about 15 milliseconds. Even further preferably, the system is adapted at transmitting transmission packs of maximally 30 milliseconds.

For the skilled artisan it is evident, that all the embodiments described above can be realized in an implementation of the present invention in any combination that is not mutually exclusive.

In the following chapter the present invention is further explained by means of specific examples and figures, without being limited thereto. The skilled artisan can derive further advantageous embodiments by studying and reviewing these examples and figures.

For the sake of convenience, the same items have been labeled with the same reference numbers in different graphics. The figures are purely schematic.

### BRIEF DESCRIPTION OF SEVERAL VIEWS OF THE DRAWINGS

FIG. 1 shows depicts schematically an embodiment of the present invention;

FIG. 2 shows a schematic representation of a device according to the present invention;

FIG. 3 shows a schematic representation of a network setup for a working of the method of the present invention;

FIG. 4a shows a sample assignment for string instrument simulation, and

FIG. 4b shows a sample assignment for piano simulation.

### DETAILED DESCRIPTION OF THE INVENTION

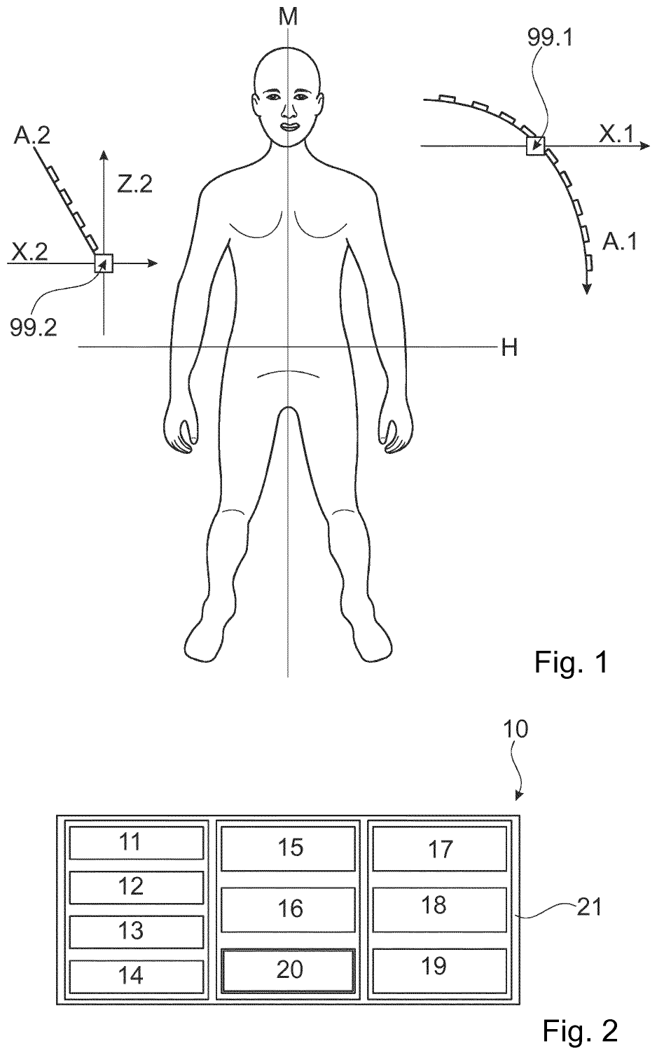

FIG. 1 shows schematically how the method of the present invention can be implemented. This example works with two devices, namely a first device 99.1 and a second device 99.2. These devices 99.1, 99.2 are operated by a user 100.

For this specific example the devices 99.1, 99.2 can be assumed to be either held in one hand each, or affixed to either the left, or the right arm, for instance by means of a strap. In the present example a left-handed user 100 has affixed a first device 99.1 to the left wrist by means of a strap. The second device 99.2 is also affixed to a wrist, namely the right wrist of the user 100. For the sake of simplified illustration, the areas of movement are defined by four quadrants. A first quadrant corresponds to movement that is easily accessible by the first device by moving the left arm and hand. This device is to the left of the median plane M of the user. This quadrant is also above the horizontal plane H of the user 100. The first device performs a continuous movement A.1. The method of the present example in this simplified illustration defines a first axis of movement X.1 of the said continuous movement A.1. In the present example, the first axis of movement x.1 corresponds to the x-axis of a Cartesian coordinate system. By means of this invention it is possible to represent the continuous movement A.1 as consisting of vectors in a cartesian, three-dimensional coordinate system.

At the same time a second device performs a second movement A.2. This movement can also be subdivided into a plurality of axial movements, whereby the axes corresponds to axes of a cartesian coordinate system with a first axis X.2, and a second axis Z.2 shown for illustrative purposes in FIG. 1. The movement of the second device 99.2 also illustrates an acceleration, i.e., a start of a continuous movement.

In the context of the present invention, the start of a continuous movement would be used to generate a midi-note-on signal. At the same time a subsequently the continuous movement would be used to generate a midi-CC-signal. This signal is attributed with a value representative of the axis where the movement is performed. The axis is defined at the time point of starting the movement in the present example and has a value of between 0 and 127, where 64 is defined as the baseline, i.e., the value where a non-movement exists. Depending on which direction along an axis the movement is performed a value of higher or lower than 64 is given to the respective movement.

FIG. 2 shows a sample arrangement of how a device adapted a detecting continuous movement can be arranged. The sample device 10 has a casing 21 in which a number of electrical components are arranged. Central to the device 10 is a nine-axis sensor 20 capable of detecting the continuous movement as well as a non-movement state. The nine-axis sensor 20 is equipped with a number of integrated orientation and movement sensors, such as at least an accelerometer, preferably a three-axial accelerometer, a gyroscope, preferably a three-axial gyroscope, a geomagnetic sensor, preferably a three-axial geomagnetic sensor, for instance. The required chipsets of the sensors can be integrated into a single pin.

The sensor can be integrated operationally connected in the device 10 by means of interfaces for connecting it to the power supply units and controller or processing units. The exemplary device 10 further comprises a signal processing unit 16 as controller, which is in a functional relationship with the nine-axis sensor 20 and receives and processes all the information provided by the nine-axis sensor 20. Most modern sensors come equipped with firmware already adapted at providing a first parameterization of the detected sensor data. If that is not the case, or if further parametrization is required or desired, the signal processing unit 16 can be adapted at providing the desired or required parameterization.

In the present example, the device is powered by an accumulator 17 functionally connected to a charging circuit 18 adapted at wirelessly charging the accumulator 17. For connecting the device 20 with a charging cable to a socket a charging connector 19 is also provided. Many presently available charging contacts, as the one used in the present implementation, are also capable of acting as a data transfer contact into which a charging/data contact, for instance a Micro USB connector, can be connected with the device 10. For this end, respective slits can be provided on the housing 20 of the device 10.

The present example also features a user interface 15. In its most basic manifestation, the user interface 15 can be a simple on/off button used to put the device into an operational state or turn it off. More sophisticated types of devices can come equipped with a touchscreen that is capable of providing access to a plurality of functions of the device. Such a user interface 15 can be used, for instance, to select an operational mode of the device 20, such as for instance the specific instrument that is to be simulated by the device 20. The user interface 15 can also be adapted at providing the device 20 with access to further auxiliary gadgets and devices, such as for instance for linking a number of devices together. In a particular example, a number of devices can be attributed to a specific channel, such that the number of devices recognizes other devices belonging to the same channel. This can be useful for instance when a plurality of devices is used by more than one person to prevent the devices from confounding each other and misrepresenting particular types of movement in their representation as music notes. In this example, all devices with the same channel know that they belong for instance to “string instrument No. 1”, whereas all the devices with another channel identify themselves as “string instrument No. 2”. For other embodiments, the channels can be attributed to a particular dancer or entertainer and the movements can be processed within the context of the channel they are attributed to.

The present device 10 further comprises a memory unit 14 for storing various instrument types and instrument attributions. This memory 14 can be characterized as a removable type of memory, such as an SD-card, or it can be fixedly integrated in the device 10. The device further comprises a microprocessor system 13.

The device has a wireless connectivity such as in the present example a Bluetooth unit 12 and a respective antenna 11. The Bluetooth unit 12 follows the Standard 5.0 for Bluetooth.

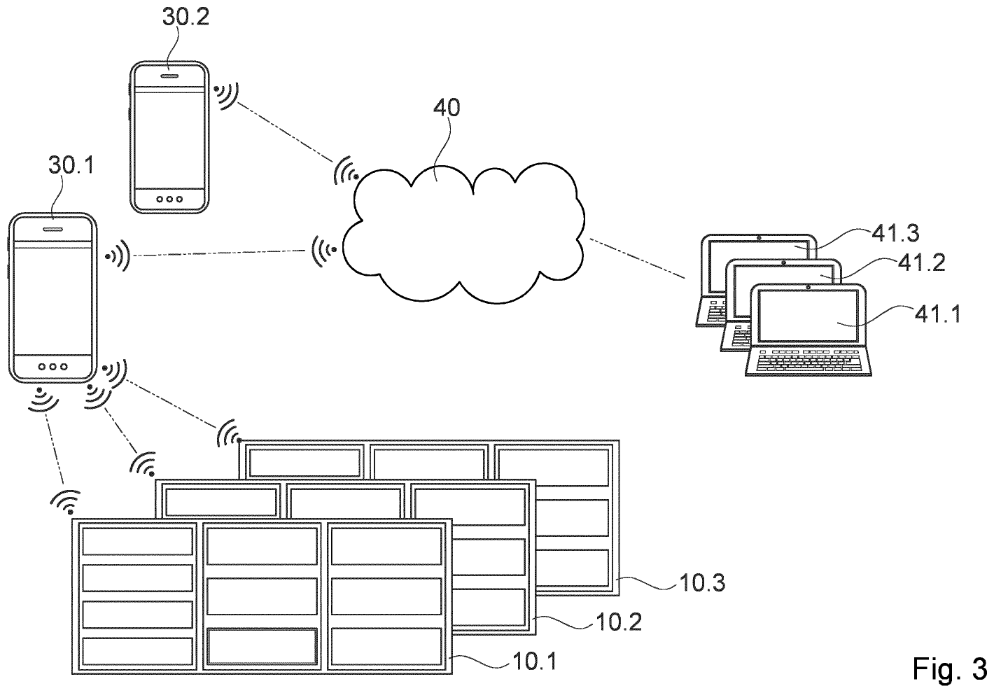

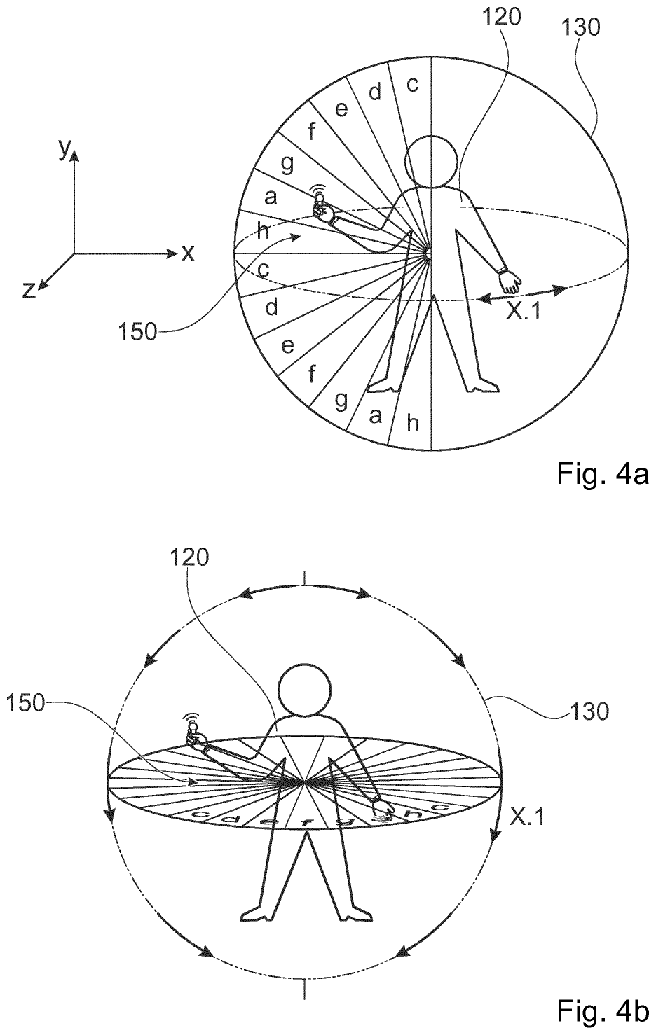

FIG. 3 shows how a number of devices 10.1, 10.2, 10.3 can be used together with a number of smartphones 30.1, 30.2 and connected by means of a cloud service 40 with a number of computers 41.1, 41.2, 41.3. The devices 10.1, 10.2, 10.3 are connected by means of a wireless Bluetooth connectivity with the smartphones 30.1, 30.2 which can provide access, for instance, to the operation modes and to the capabilities of the devices 10.1, 10.2, 10.3. The smartphones can be connected by means of a mobile network with a cloud database 40 that can provide a repository for instrument settings and note sets (as shown in the examples of FIG. 4a, 4b, below) and can be used as distribution system for content generated on computers 41.1, 41.2, 41.3.

By means of the setup shown in FIG. 3, a distribution of different type of instrument configurations can be established.

For this example, all three axes of movement are used in the cartesian coordinate system and used for generating three midi-CC-signals for outputting a sound effect. In this example a movement along the y-axis is used to trigger a midi-on note and a tone and determine the tone length by means of a relative midi-CC-channel. The absolute midi-CC-value determines the pitch of the tone.

A relative midi-cc-Message outputs a speed of orientational change of the sensor. The original position of orientation does not matter. The relative midi-cc-Message reflects the relative change of orientation.

An absolute midi-cc-message outputs an exact orientation of the sensor in space in terms of x, y, or z axis. The absolute midi-cc-message reflects the absolute orientation of the sensor regardless of speed and relative change of orientation.

For the simulation of a string instrument the value of a relative midi-CC-channel in the y-axis is determined by a left-right movement. As soon as this value is higher than 64 (for instance 65, or 66 whereby the threshold value can be predetermined) a midi-one note is triggered. This midi-one note is maintained as long as no midi-off note is triggered. This is not triggered for as long as the value remains above 64. As soon as the value reaches 64 a midi-off note is triggered. If the value drops below 64, though a further midi-on note is triggered which is maintained for as long as the value remains below 64. This simulates the exact behavior of bowing. The tone pitch is controlled with the second hand and a second device which in a real string instrument would be holding the strings and also be used to control pitch. These are predetermined to be connected with an absolute value of a y-axis, which can be defined in the present example as generating high midi-cc-values for as long as the hand remains points upwards and generate low midi-cc-values as soon as or for as long as a hand points downwards. This midi-cc-values have been linked to a pitch value of the midi-one note triggered by the relative midi-cc value.

For this particular example the octaves can be mapped to the values 0 to 127 and it can be adjustable by a user or predetermined by the device or software if a value is between 1 or 8 octaves. The more octaves a value is set for, the more the resolution of the notes can be increased. In a particular example, this means, that a high resolution is achieved if many octaves are placed in an axis, for instance the Y-axis. All the octaves are placed in order and the distances between subsequent notes are equidistant.

In an alternative or additional aspect, each note is attributed with an angular range in a particular axis with regard to an orientation of the sensor or sensing device. For instance, an angular range of between 0 and 5 degrees is attributed to the note A, an angular range of between 5 and 10 degrees with a note B, etc. The skilled artisan readily understands, that this attribution is only explained as an illustrative example and ultimately is discretionary for the performance or type of instrument the method is intended to simulate.

A fast movement generates a high cc-Value in the axis x, y or z, or all of them summed up. This cc-value is mapped to the volume-value of a sound. This leads to louder sounds in faster movements, and silent sounds in slow movements.

FIG. 4a is provided for illustrating an assignment of notes as workable in the context of the present invention for a string instrument implementation. The note on is controlled by movement in the x-axis relative to the operator 120 inside the movement range 130. The pitch is controlled by means of movement in the y-axis. The orientation of the sensing device inside the movement range 130 determines which musical note is output.

Of course, the more notes are arranged in a given arch, the more precise the movements have to be to hit the correct note. The shown representation in FIG. 4a is thus a sample implementation of the present invention.

The musical notes are arranged in wedge-shaped sectors with a particular angle relative to a predetermined origin. Orienting the device in that specific angle results in emission of the note attributed to theta wedge-shaped vector. Movement in the X-Axis generates the midi note-on and a pitch is controlled by movement in the Y-axis.

It has surprisingly been found, that attributing the notes inside a movement range 130 of an operator 120 and attributing the notes to a particular orientation of the sensing device results in an intuitive approach and is fast to learn for operators 120.

The attributed notes, the definition of the note-on and the pitch all come surprisingly natural and intuitive to a string instrument player, providing an excellent training device that is easily storable and can be carried everywhere.

### Example 2 Piano

For a piano simulation, a virtual keyboard is defined close to or around a horizontal plane of the user. Depending on the orientation of the hand with the device a different type of tonal sound is played. The keyboard therefore is an imaginary keyboard around the user. The tonal sound is triggered with a relative midi-CC in the y-axis as soon as the hand is moved with a threshold intensity and remains for as long as the movement persists.

The respective sample representation of a piano implementation in FIG. 4b follows a different approach than the one depicted for the string instrument, above in in FIG. 4a.

In this arrangement, the note-on is determined by movement in the y-axis, whereas the pitch is controlled by movement in the x-axis. To support the piano players used to operating a piano in the axial or horizontal axis, the circular arrangement around the operator 120 is chosen inside the movement range 130 as axial and normal to the operator. As with the string instrument above, the wedge-shaped vectors define musical notes. This has been found to provide the most intuitive approach for a piano simulation.

### Example 3 Guitar

For this particular example sectors are defined around the wrist rotation axis of the hand where the device is held or affixed to. Each string is mapped to a particular position angle of the wrist. For instance, five strings with different tonal pitches can be mapped to a particular wrist rotation. Like this the user can trigger the sound effects by rotating the wrist in a movement that is similar as letting the hand drop on the strings of a real guitar. The second hand can be used to control pitch for each string. This can generate an adequate simulation of playing a guitar in the air.

1. A method for creating a sound effect out of a continuous movement, comprising the steps of:
a. providing a first device (99.1) adapted to detect continuous movement (A.1) and a no-movement state;
b. defining at least one first parameter of movement, in particular whereby the first parameter of movement is a first axis of movement (X.1) of the continuous movement;
c. assigning at least one first midi-channel to the first parameter of movement (X.1);
d. defining a baseline value for the no-movement state, and defining along the first parameter of movement of (X.1) a range of values relative to the baseline value and reflective of a continuous movement along the first parameter of movement;
e. outputting a sound effect relative to the detected continuous movement.

2. The method according to claim 1, whereby the first parameter of movement is an angular range in one axis X, Y, Y, Z of an orientation in space of the first device (99.1) adapted at detecting continuous movement (A.1) and a no-movement state.

3. The method according to claim 1, where a single musical note is attributed to a wedge-shaped sector defining a particular angle relative to a predetermined origin within a movement range 130 of an operator and the device is adapted to detect movement within a particular wedge-shaped sector and relate it to the single musical note.

4. The method according to claim 1, wherein the device (99.1) is further adapted to detect an end and/or a start of the non-movement state.

5. The method according to claim 1, whereby at least one second device (99.2) is provided adapted to detect a second continuous movement (A.2) and a second no-movement state.

6. The method according to claim 1, whereby a sound volume is attributed to a speed of a continuous movement.

7. The method according to claim 1, further comprising assigning a midi-note-on to an end of the non-movement state.

8. The method according to claim 1, whereby the outputting is performed by an outputting device.

9. The method according to claim 1, further comprising one of receiving at least one first midi-channel with an outputting device and receiving a plurality of midi-channels from a plurality of devices (99.1, 99.2) adapted at detecting continuous movement (A.1, A.2; B.1, B.2; C.1; C.2) and a no-movement state, such that a plurality of midi-channels is generated from the plurality of continuous movements detected.

10. The method according to claim 9, whereby a priority is attributed to the midi-channels received by the outputting device, whereby priority is attributed to the midi-channel with the greatest change in continuous movement.

11. The method according to claim 8, whereby the receiving is a wireless receiving, on particular a wireless receiving by means of short-wavelength radio waves, even more particularly a Bluetooth protocol.

12. The method according to claim 1, whereby at least one second axis (Y.1) and/or at least one third axis (Z.1) is defined for the continuous movement (A.1).

13. The method according to claim 1, whereby the first device (99.1) adapted at detecting continuous movement (A.1) and a no-movement state is assigned to an anatomical plane of the user (F, G, H) and the sound effect relative to the detected continuous movement in that anatomical plane is a predetermined sound effect for that plane (F, G, H).

14. The method according to claim 13, whereby a plurality of devices is provided and to each device an anatomical plane of the user (F, G, H) is assigned and the sound effect relative to the detected continuous movement in that anatomical plane is a predetermined sound effect for that plane (F, G, H).

15. The method according to claim 1, whereby the midi-channel is a midi-CC channel and the values are values ranging from 0 to 127.

16. The method according to claim 15, where the baseline value is set at 64 and for a movement in a first direction (f1) along the first axis of movement (X.1) the range of values relative to the baseline value ranges from 0 to 63 and for a movement in a second direction (f2) along the first axis of movement (X.1) the range of values relative to the baseline value ranges from 65 to 127.

17. The method according to claim 1, whereby the a. providing a first device (99.1) adapted at detecting continuous movement (A.1) and a no-movement state comprises providing a device with a processing unit adapted to recognize a pre-learned movement sequence out of force signal(s) detected by at least one sensor, for generating a force signal from the at least one detected force, in particular by applying a machine learning algorithm, and converting the movement sequence into a digital auditory signal, in particular a MIDI-signal.

18. The method according to claim 1, whereby the device is adapted to be affixed to an extremity of a user.

19. The method according to claim 1, whereby at least one second parameter of movement is defined as an orientation of the first device (99.1) adapted at detecting continuous movement (A.1) and a no-movement state in space.

20. A system for managing transmissions of a plurality of devices adapted at detecting a movement and generating a movement specific midi signal, in particular a midi-on note and/or a midi-off note and/or a midi-cc channel with values ranging from 0 to 127, whereby
a. the transmissions are wirelessly transmitted from the plurality of devices to an output unit;
b. each signal comprising information convertible to a sound effect by the output unit;
c. each signal is output with a latency between a force sensing and output by the output unit of maximally 30 ms, in particular of between 10 and 20 ms;
d. each signal is packed in a transmission pack consisting of four information blocks selected from the group consisting of midi-on note and/or a midi-off note and/or a midi-cc channel; and wherein
e. the transmission packs are prioritized in that the transmissions with signals containing the highest variation are preferred, and/or
f. the transmission packs with midi-on information blocks are prioritized.
